(19) United States
(12) Patent Application Publication
(10) Pub. No.: US 2026/0018079 A1
(43) Pub. Date: Jan. 15, 2026

(54) SYSTEMS AND METHODS FOR ARTIFICIAL INTELLIGENCE INTERACTIVE TUTORING

(71) Applicant: Emily Levy-Gutter, Demarest, NJ (US)

(72) Inventor: Emily Levy-Gutter, Demarest, NJ (US)

(21) Appl. No.: 19/265,614

(22) Filed: Jul. 10, 2025

Related U.S. Application Data
(60) Provisional application No. 63/670,189, filed on Jul. 12, 2024.

(51) Int. Cl. G09B 7/04; G09B 5/06

(52) U.S. Cl. CPC G09B 7/04; G09B 5/06

(57) ABSTRACT

An interactive AI-enhanced tutoring system and method for adaptive writing instruction are disclosed. The system features a processing device running an instructional application with an AI teaching module that evaluates baseline writing samples to determine user proficiency. Based on this evaluation, the system provides tailored learning modules, ranging from sentence structure to essays. Machine learning algorithms score responses on grammar, style, and content, offering actionable feedback to improve skills. A user writing portfolio tracks progress, while an educator dashboard, accessible via a communications interface, allows remote monitoring of performance metrics and trends. The method includes receiving writing samples, evaluating proficiency, delivering adaptive modules, scoring responses, and providing feedback. This system enables autonomous, real-time writing instruction without requiring live tutors.

### CROSS-REFERENCE TO RELATED APPLICATION

This application claims the benefit of priority of U.S. provisional application No. 63/670,189, filed Jul. 12, 2024, the contents of which are herein incorporated by reference.

### FIELD OF ENDEAVOR

The present disclosure relates to an interactive teaching tool for writing instruction and, more particularly, to artificial intelligence-enhanced interactive teaching tools for scoring student writing and providing direct feedback.

### BACKGROUND OF THE INVENTION

Conventional tutoring and teaching methods for writing instruction utilize both traditional and modern technologies to address diverse learning needs. From an electronic perspective, students can submit their written work via computer application and receive feedback or solutions from tutors and teachers at a later time. These processes, however, are asynchronous and not interactive. Tutors and teachers can also use video conferencing tools to connect tutors and students in real-time, providing interactive writing instruction. Yet these processes require the live participation of a tutor.

As can be seen, there is a need for systems and methods that address the above drawbacks.

### SUMMARY OF THE INVENTION

In one embodiment, a computer implemented method for adaptive tutoring is disclosed. In this embodiment, a processor receives one or more writing samples from a user and evaluates the samples using one or more artificial intelligence models to determine the user's educational level. The processor then provides learning modules to the user adaptively based on the determined educational level. The method further includes receiving responses from the user to the learning modules, reevaluating these responses using the artificial intelligence models to determine a score or to generate user feedback, and outputting at least one of the score, the user feedback, or an additional learning module. In some embodiments, the writing samples are received in response to a baseline writing sample, and the additional learning module is provided adaptively based on the score.

In another embodiment, a system for adaptive tutoring is provided. The system comprises at least one processor and memory storing instructions that, when executed, cause the processor to perform a method substantially similar to the computer implemented method described above. In this embodiment, the processor receives writing samples from the user, evaluates the samples using one or more artificial intelligence modules to determine the user's educational level, and provides learning modules adaptively based on this educational level. The system further receives responses to the learning modules, evaluates these responses to generate a score or user feedback, and outputs at least one of the score, the user feedback, or an additional learning module. As with the method embodiment, the writing samples in some implementations are received in response to a baseline writing sample and the additional learning module is adaptively output based on the score.

In yet another embodiment, a system for interactive artificial intelligence-enhanced writing tutoring is disclosed. This system comprises a processing device configured to execute an instructional application stored in memory, the instructional application including an artificial intelligence teaching module. The teaching module is configured to receive a baseline writing sample from a user via a user interface, evaluate the sample to determine a writing proficiency level, and generate tailored learning modules based on this determined proficiency level. The system receives responses from the user to the tailored learning modules and evaluates the responses to generate a performance score and user feedback, while also updating a user writing portfolio based on the evaluated responses. Additionally, the system includes a communications interface to transmit and receive data with a remote educator dashboard, an output interface to display at least one of the performance score, the user feedback, or additional learning modules provided adaptively based on the evaluated responses, and an educator dashboard configured to present user performance metrics, including historical performance score trends. In some embodiments, the artificial intelligence teaching module comprises one or more machine learning algorithms trained to evaluate grammatical correctness, writing style, and content organization, and the tailored learning modules include options such as a sentence structure module, a simple paragraph module, an extended paragraph module, or a five paragraph essay module.

### BRIEF DESCRIPTION OF THE DRAWINGS

FIG. 1 is a diagram of an interactive learning environment including an instructional system for teaching writing, according to aspects of the present disclosure;

FIG. 2A is a screenshot of a graphical user interface generated by the writing tutoring system, according to aspects of the present disclosure;

FIG. 2B is a screenshot of a graphical user interface generated by the writing tutoring system, according to aspects of the present disclosure;

FIG. 2C is a screenshot of a graphical user interface generated by the writing tutoring system, according to aspects of the present disclosure;

FIG. 2D is a screenshot of a graphical user interface generated by the writing tutoring system, according to aspects of the present disclosure;

FIG. 2E is a screenshot of a graphical user interface generated by the writing tutoring system, according to aspects of the present disclosure;

FIG. 2F is a screenshot of a graphical user interface generated by the writing tutoring system, according to aspects of the present disclosure;

FIG. 2G is a screenshot of a graphical user interface generated by the writing tutoring system, according to aspects of the present disclosure;

FIG. 2H is a screenshot of a graphical user interface generated by the writing tutoring system, according to aspects of the present disclosure;

FIG. 2I is a screenshot of a graphical user interface generated by the writing tutoring system, according to aspects of the present disclosure; and

FIG. 3 is a flow chart of an interactive learning method, according to aspects of the present invention.

### DETAILED DESCRIPTION OF THE DISCLOSURE

The following detailed description is of the best currently contemplated modes of carrying out exemplary embodiments of the disclosure. The description is not to be taken in a limiting sense but is made merely for the purpose of illustrating the general principles of the disclosure, since the scope of the disclosure is best defined by the appended claims.

As discussed above, current teaching and tutoring tools for writing instruction lack the ability to provide autonomous, real-time instruction to students. Broadly, an embodiment of the present disclosure provides a tutoring system and software application that assist students with structured, multisensory writing instruction and artificial intelligence (AI) driven feedback. The writing tutoring system and application can generate a baseline assessment to identify a student's writing level and the appropriate starting point in the program. The writing tutoring system and application guide students through tailored learning modules, from basic sentence structures to five paragraph essays. The tutoring system and application operate an AI-driven scoring system that objectively scores student's work and provides direct, actionable feedback to help students enhance their writing level. The writing tutoring system and application stores and updates writing portfolios for ongoing progress assessment.

The writing tutoring system and application generate and present an educator dashboard that enables tutors/teachers to analyze and monitor student progress and growth in the educational writing process. Moreover, objective assessments reduce the traditional grading subjectivity, offering clear and consistent evaluations. The AI-generated direct feedback motivates students to actively improve their writing skills.

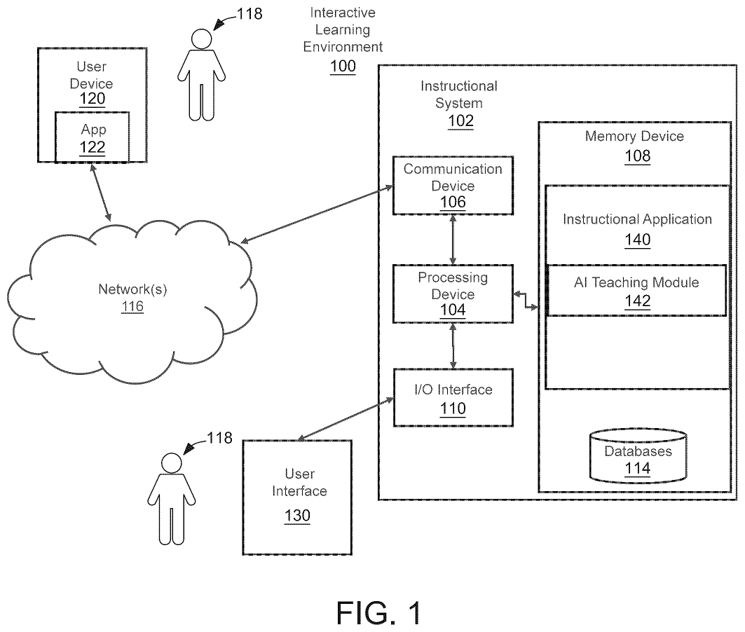

Referring now to FIGS. 1, 2A-2I and 3, FIG. 1 illustrates an interactive learning environment 100 including an instructional system 102, according to aspects of the present disclosure. While FIG. 1 illustrates examples of components of the instructional system 102, additional components can be added and existing components can be removed and/or modified.

As illustrated in FIG. 1, the instructional system 102 includes a processing device 104 coupled to a communication device 106. The processing device 104 is also coupled to a memory device 108, and an input/output (“I/O”) interface 110. In embodiments, the communication interface 106 enables the instructional system 102 to communicate with other devices and systems via one or more networks 116. The instructional system 102 can communicate with a user 118, operating a user device 120, via the network 116, to provide the instructional services described herein. The user device 120 can include one or more electronic devices such as a laptop computer, a desktop computer, a tablet computer, a smartphone, a thin client, and the like.

According to the aspects of the present disclosure, the instructional system 102 can store and execute a copy of an instructional application 140. To perform the process described herein, the instructional application 140 can store and execute an AI teaching module 142 to perform the processes and methods described herein. The instructional application 140, including the AI teaching module 142, can be stored in the memory device 108. The instructional application 140, including the AI teaching module 142, can include the necessary logic, instructions, and/or programming to perform the processes and methods described herein. The instructional application 140, including the AI teaching module 142, can be written in any programming language.

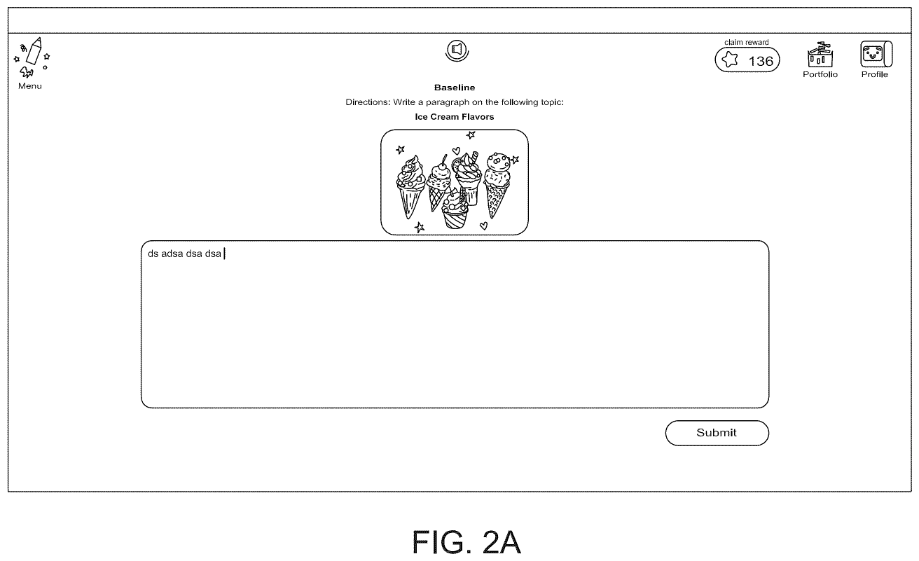

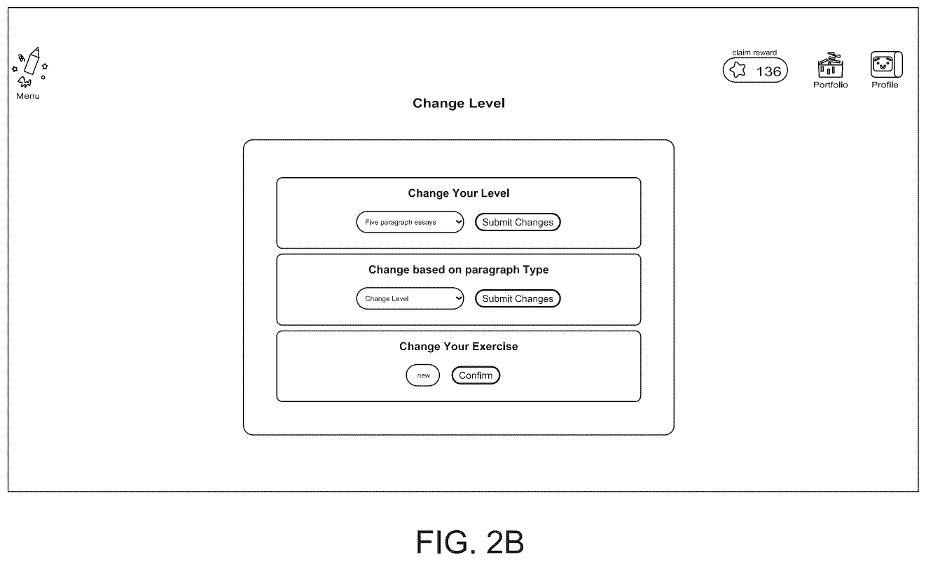

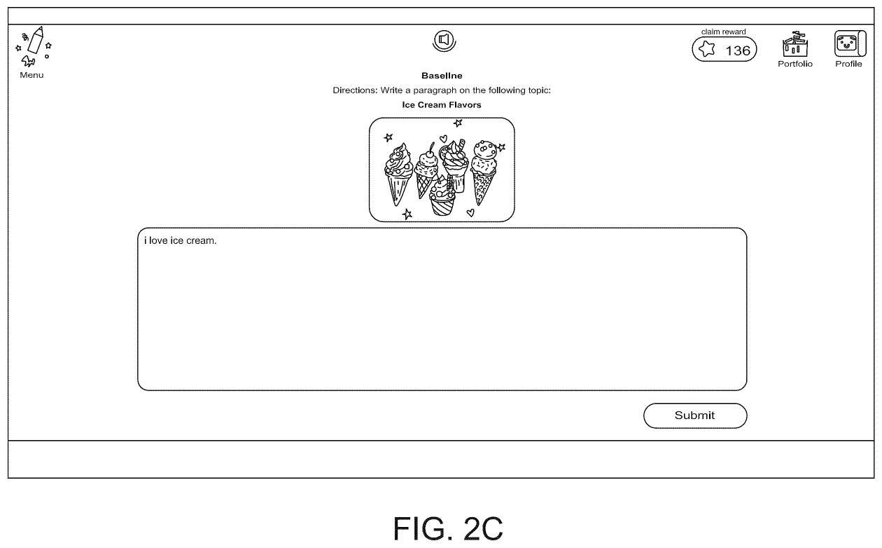

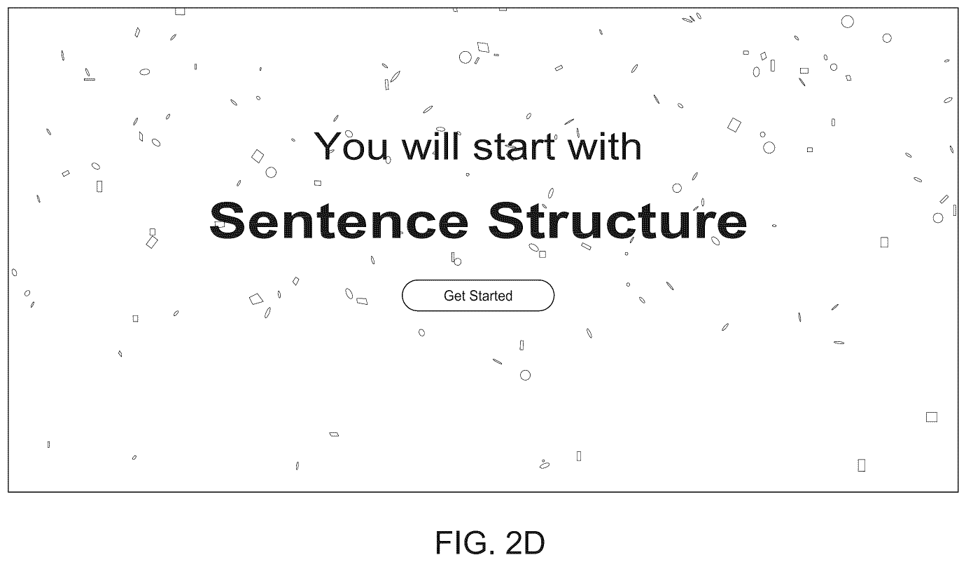

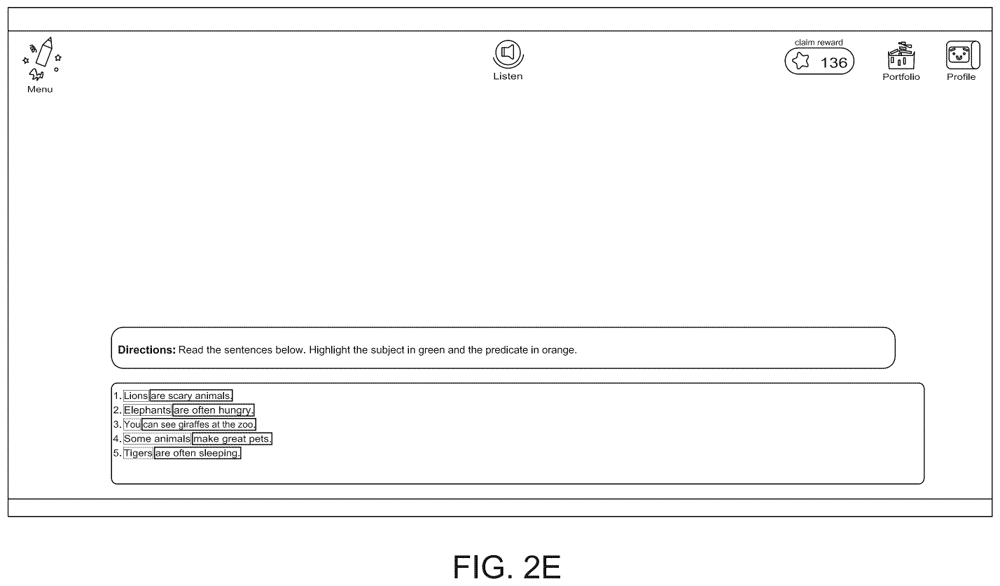

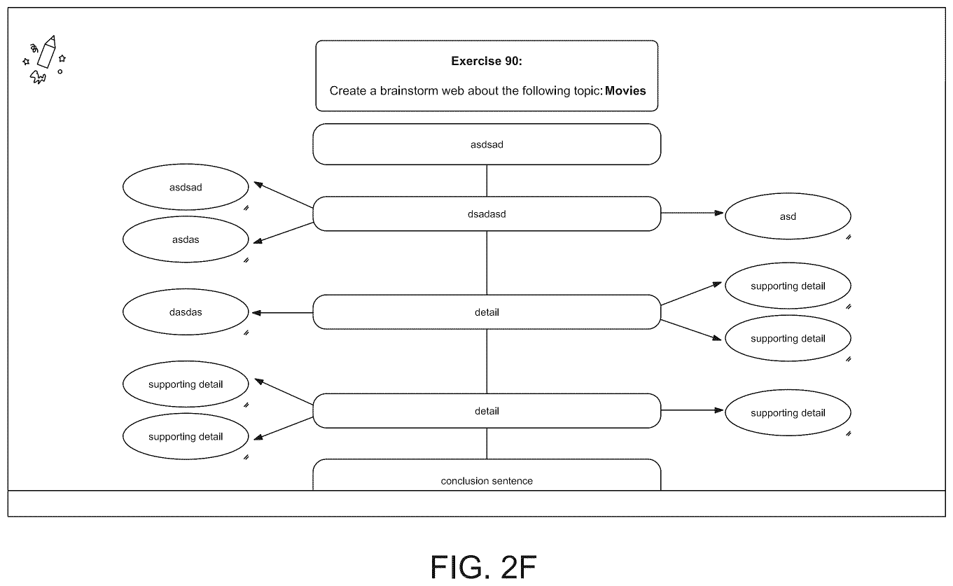

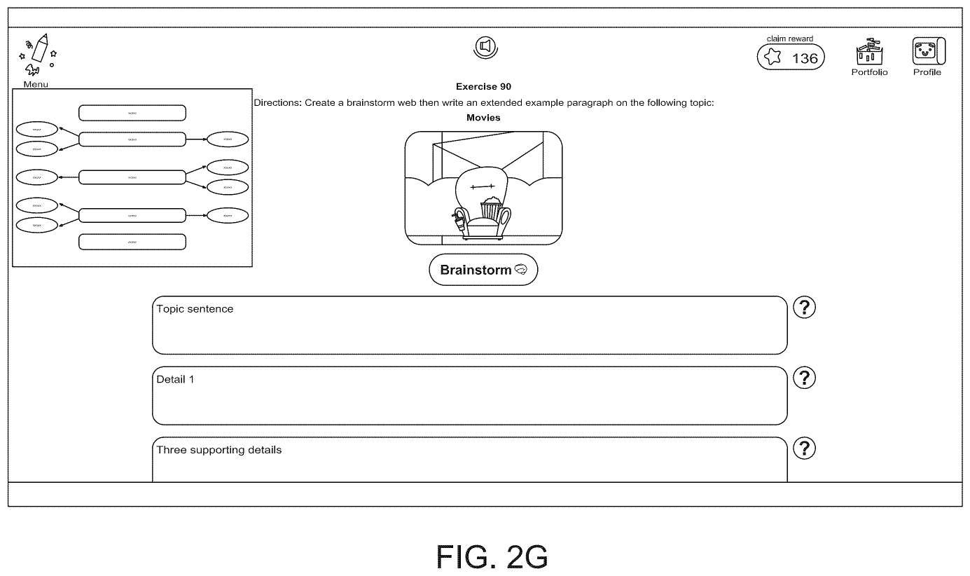

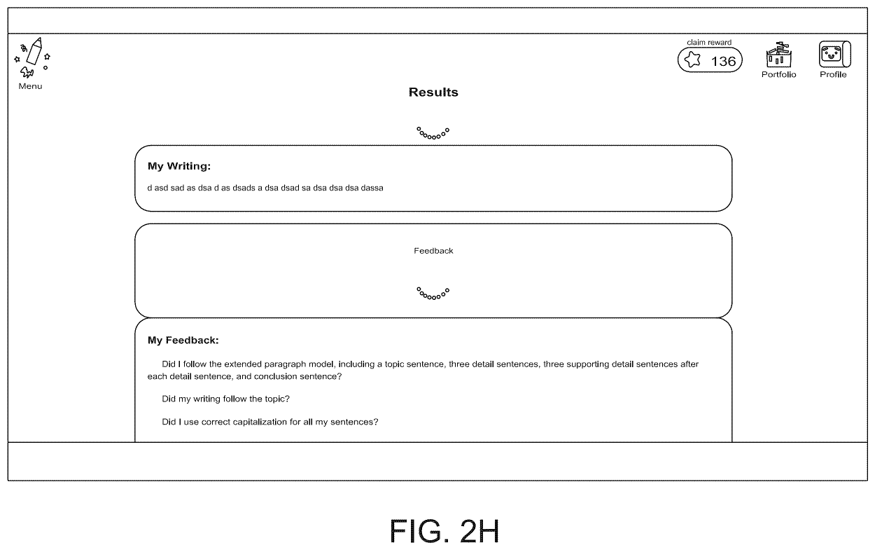

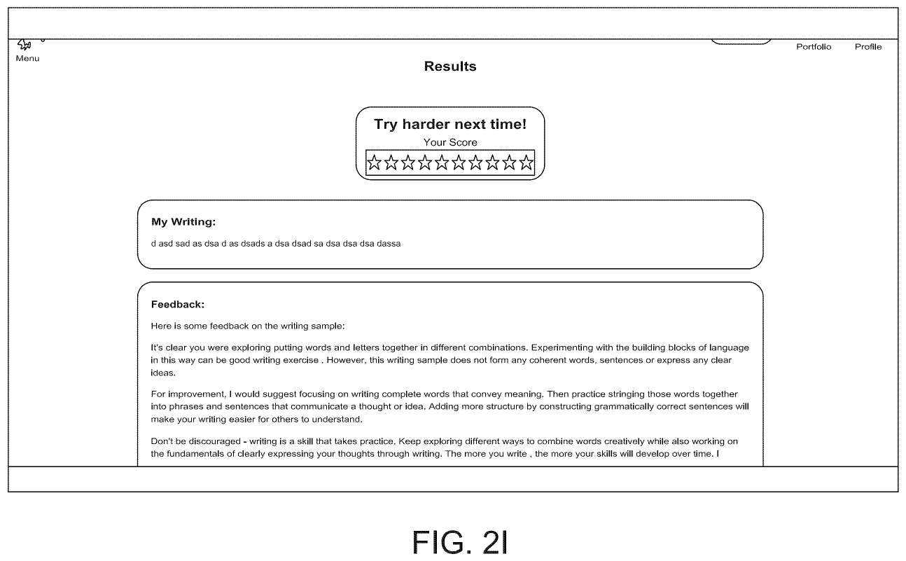

The instructional application 140 operates to provide an interactive learning environment for the user 118 that is driven by the AI teaching module 142. The instructional application 140 operates to generate and provide graphical user interfaces (GUIs), for example, menus, widgets, text, images, fields, etc., that provide learning guide instruction and AI generated feedback. For example, the instructional application 140 can be configured to provide instruction on writing and language skills. FIGS. 2A-2I illustrate examples of the GUIs that can be generated in the teaching process.

The instructional application 140 can generate a series of GUIs that quiz the user 118 in order to generate a baseline assessment to identify education level, for example, their writing levels and starting points in the program. Once the baseline assessment is established, the instructional application 140 guides the user 118 through tailored learning modules, from basic sentence structures to five paragraph essays.

The instructional application 140 via the AI teaching module 142 objectively scores the work of the user 118 and provides direct, actionable feedback to help students enhance their writing skills. The AI teaching module 142 includes one or more machine learning algorithms that are trained to score the work of user 118. The one or more machine learning algorithms can be trained to score the work based on more or more writing criteria that are weighted, for example, based on contextual rules. The AI teaching module 142 can be configured to score the user 118 and provide feedback to the user. For example, the AI teaching module 142 can provide a grade or progress level. The AI teaching module 142 can provide feedback based on the particular work submitted by the user 118. For example, if a writing sample of the user 118 includes a spelling error or grammatical error, the AI teaching module 142 can explain the error and provide feedback to correct the error. In another example, if a writing sample is technically correct, the AI teaching module 142 can provide feedback to improve the sentence and improve the score.

In embodiments, AI teaching module 142 implements a Temporal-Semantic Fusion Network (TSFN) utilizing a Dual-Stream Transformer Architecture that simultaneously processes both textual content and temporal writing patterns of the user 118. In embodiments, textual content is processed utilizing a modified Bidirectional Encoded Representations from Transformers-based (BERT) model with custom attention heads optimized for educational assessment. In embodiments, the modified BERT model includes domain-specific tokenization for academic writing; positional encoding adjusted for sentence-level coherence analysis; and Multi-task output heads for grammar, style, and content scoring. In embodiments, temporal writing patterns are processed dynamically, in real-time, dynamics through a Temporal Convolutional Network (TCN) with dilated causal convolutions capturing long-range temporal dependencies, gated activation units for pattern recognition in writing pauses, and cross-attention layers linking temporal features to semantic content. In embodiments, processed textual content and temporal content are fused utilizing a Feature Fusion Gate that utilizes learned weights from a small neural network that dynamically adjusts semantic-temporal integration based on writing task complexity. The results of the fusion are fed to one or more additional machine learning algorithms for scoring and evaluation.

In embodiments, scoring and/or evaluation of one or more works of the user 118 is performed by one or more machine learning algorithms of AI teaching module 142. In embodiments, the one or more machine learning algorithms are implements as a Reinforcement Learning-Based Weighting Controller that automatically adjusts scoring criteria weights based on one or more of: Student proficiency level, Writing task type, Common Core State Standards alignment, and/or Historical error patterns. The Controller is implemented as a Deep Deterministic Policy Gradient (DDPG) agent with continuous action space representing weight adjustments, which includes a state space of: Real-time writing features (lexical diversity, syntactic complexity), Longitudinal performance metrics, and/or Cognitive load estimates from temporal analysis stream. In embodiments, the TSFN along with additional data streams are provided to the Controller to aid in scoring and/or evaluation of the user's 118 work. For example, one or more of text processed utilizing the textual content, the temporal writing patterns, one or more revision histories processed utilizing a Graph Neural Network, one or more Stylometry features determined utilizing an ensemble of shallow classifiers, one or more metadata from embedding layers, and/or one or more audio feedback processed using a Spectrogram CNN, are fused and utilized for evaluation and scoring of user's 118 work.

In embodiments, to prevent gaming of the AI teaching module 142, a Triple-Network Adversarial Architecture is implemented, to train one or more machine learning algorithms of the AI Teaching module 142. The Triple-Network Adversarial Architecture includes, but is not limited to: a Generator Network, a Discriminator Network, and an Assessment Network. The Generator Network is a conditional Generative Adversarial Network (GAN) configured to produce synthetic writing samples attempting to maximize assessment scores. The Discriminator Network is a multi-head Convolutional Neural Network (CNN) configured to distinguish real vs. synthetic writing samples while predicting writing quality. The Assessment Network is the primary scoring model trained against adversarial examples from Generator Network. In embodiments, the networks engage in continuous adversarial training through a modified Wasserstein loss function with gradient penalty terms specific to educational content characteristics.

The instructional application 140 can also provide a dashboard that allows other users, e.g., parents, teachers, tutors, etc., to monitor the process of the user 118. The instructional application 140 stores and updates portfolios for ongoing progress assessment. The memory device 108 can also include a database 114 that stores information and data associated with the process and methods described herein. The database 114 can store the data used for the instruction and portfolio for the user 118. The database 114 can be any type of database, for example, a hierarchical database, a network database, an object-oriented database, a relational database, a non-relational database, an operational database, and the like.

In embodiments, the user 118 can interact remotely with the instructional system 102 using the user device 122. For example, the user devices can store and execute an application 122. In some embodiments, the application 122 can be a specifically designed application that operates with the system 102 to perform the processes and methods described herein. In some embodiments, the application 122 can be a third-party application, such as a web browser, that communicates with the instructional system 102 to perform the processes and methods described herein.

In embodiments, the user 118 can interact directly with the instructional system 102 using a user interface 130. For example, the instructional system 102 can communicate with the user interface via the I/O interface 112. The user interface 130 can display GUIs generated by the instructional system 102. The user interface 130 can include a display screen such as a light-emitting diode (“LED”) display, an organic LED (“OLED”) display, an active-matrix OLED (“AMOLED”) display, a liquid crystal display (“LCD”), a thin-film transistor (“TFT”) LCD, a plasma display, a quantum dot (“QLED”) display, and so forth. The user interface 130 can include an acoustic element such as a speaker, a microphone, and so forth. The user interface can include a button, a switch, a keyboard, a touch-sensitive surface, a touchscreen, a camera, a fingerprint scanner, and so forth. The touchscreen can include a resistive touchscreen, a capacitive touchscreen, and so forth.

The processing device 104, the communication device 106, the memory device 108, and the I/O interface 110 can be interconnected via a system bus. The system bus can be and/or include a control bus, a data bus, an address bus, and the like. The processing device 104 can be and/or include a processor, a microprocessor, a computer processing unit (“CPU”), a graphics processing unit (“GPU”), a neural processing unit, a physics processing unit, a digital signal processor, an image signal processor, a synergistic processing element, a field-programmable gate array (“FPGA”), a sound chip, a multi-core processor, and the like. As used herein, “processor,” “processing component,” “processing device,” and/or “processing unit” can be used generically to refer to any or all of the aforementioned specific devices, elements, and/or features of the processing device. While FIG. 1 illustrates a single processing device 104, the instructional system 102 can include multiple processing devices 104, whether the same type or different types.

The memory device 108 can be and/or include one or more computerized storage media capable of storing electronic data temporarily, semi-permanently, or permanently. The memory device 108 can be or include a computer processing unit register, a cache memory, a magnetic disk, an optical disk, a solid-state drive, and the like. The memory device can be and/or include random access memory (“RAM”), read-only memory (“ROM”), static RAM, dynamic RAM, masked ROM, programmable ROM, erasable and programmable ROM, electrically erasable and programmable ROM, and so forth. As used herein, “memory,” “memory component,” “memory device,” and/or “memory unit” can be used generically to refer to any or all of the aforementioned specific devices, elements, and/or features of the memory device 108. While FIG. 1 illustrates a single memory device 108, the instructional system 102 can include multiple memory devices 108, whether the same type or different types.

The communication device 106 enables the instructional system 102 to communicate with other devices and systems. The communication device 106 can include hardware and/or software for generating and communicating signals over a direct and/or indirect network communication link. As used herein, a direct link can include a link between two devices where information is communicated from one device to the other without passing through an intermediary. For example, the direct link can include a Bluetooth™ connection, a Zigbee connection, a Wifi Direct™ connection, a near-field communications (“NFC”) connection, an infrared connection, a wired universal serial bus (“USB”) connection, an ethernet cable connection, a fiber-optic connection, a firewire connection, a microwire connection, and so forth. In another example, the direct link can include a cable on a bus network. programming installed on a processor, such as the processing component, coupled to the antenna.

An indirect link can include a link between two or more devices where data can pass through an intermediary, such as a router, before being received by an intended recipient of the data. For example, the indirect link can include a WiFi connection where data is passed through a WiFi router, a cellular network connection where data is passed through a cellular network router, a wired network connection where devices are interconnected through hubs and/or routers, and so forth. The cellular network connection can be implemented according to one or more cellular network standards, including the global system for mobile communications (“GSM”) standard, a code division multiple access (“CDMA”) standard such as the universal mobile telecommunications standard, an orthogonal frequency division multiple access (“OFDMA”) standard such as the long term evolution (“LTE”) standard, and so forth.

The instructional system 102 can communicate with one or more network resources via the network 116. The one or more network resources can include external databases, social media platforms, search engines, file servers, web servers, or any type of computerized resource that can communicate with the instructional system 102 via the network 116.

In embodiments, the components and functionality of the instructional system 102 can be hosted and/or instantiated on a “cloud” and/or “cloud service.” As used herein, a “cloud” and/or “cloud service” can include a collection of computer resources that can be invoked to instantiate a virtual machine, application instance, process, data storage, or other resources for a limited or defined duration. The collection of resources supporting a cloud can include a set of computer hardware and software configured to deliver computing components needed to instantiate a virtual machine, application instance, process, data storage, or other resources. For example, one group of computer hardware and software can host and serve an operating system or components thereof to deliver to and instantiate a virtual machine. Another group of computer hardware and software can accept requests to host computing cycles or processor time, to supply a defined level of processing power for a virtual machine. A further group of computer hardware and software can host and serve applications to load on an instantiation of a virtual machine, such as an email client, a browser application, a messaging application, or other applications or software. Other types of computer hardware and software are possible.

In embodiments, the components and functionality of the instructional system 102 can be and/or include a “server” device. The term server can refer to functionality of a device and/or an application operating on a device. The server device can include a physical server, a virtual server, and/or cloud server. For example, the server device can include one or more bare-metal servers such as single-tenant servers or multiple-tenant servers. In another example, the server device can include a bare metal server partitioned into two or more virtual servers. The virtual servers can include separate operating systems and/or applications from each other. In yet another example, the server device can include a virtual server distributed on a cluster of networked physical servers. The virtual servers can include an operating system and/or one or more applications installed on the virtual server and distributed across the cluster of networked physical servers. In yet another example, the server device can include more than one virtual server distributed across a cluster of networked physical servers.

Various aspects of the systems described herein can be referred to as “content” and/or “data.” Content and/or data can be used to refer generically to modes of storing and/or conveying information. Accordingly, data can refer to textual entries in a table of a database. Content and/or data can refer to alphanumeric characters stored in a database. Content and/or data can refer to machine-readable code. Content and/or data can refer to images. Content and/or data can refer to audio and/or video. Content and/or data can refer to, more broadly, a sequence of one or more symbols. The symbols can be binary. Content and/or data can refer to a machine state that is computer-readable. Content and/or data can refer to human-readable text.

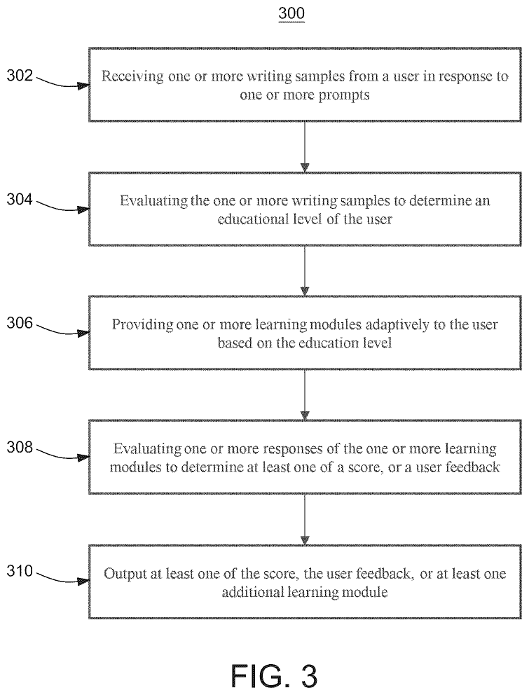

FIG. 3 illustrates a method 300 for interactive and adaptive writing tutoring. While FIG. 3 illustrates examples of one or more steps of method 300, additional steps can be added, and existing components can be removed and/or modified. Briefly, and described in more detail below, method 300 includes a baseline assessment of a user's writing capabilities, and provides one or more lessons in response to the baseline assessment. The one or more lessons are analyzed by one or more AI models configured to score, and/or provide feedback, such as but not limited to strengths, weaknesses and feedback. In embodiments, method 300 is implemented in a computing environment, such as Interactive Learning Environment 100.

At step 302, a user, such as user 118, provides a baseline writing sample which is received by the computing environment, such as Environment 100. In embodiments, one or more prompts, or directions are provided to user 118 associated with providing the baseline writing sample. The one or more prompts include, but are not limited to one or more instructions, and/or one or more topics. In an exemplary embodiment, Environment 100 through instructional application 140 can generate one or more of GUIs including the one or more instructions to user 118, such as “Write a paragraph on the following topic”, and/or the one or more topics, such as “Ice Cream”, wherein user 118 provides a baseline writing response utilizing the one or more instructions and/or the one or more topics by entering/submitting one or more writing samples into the one or more GUIs. The one or more writing samples are received by Environment 100 for use in evaluating an education level of user 118.

At step 304, the one or more writing samples are evaluated to determine an educational level of user 118. In embodiments, evaluating the one or more writing samples are performed by one or more AI or machine learning models/algorithms. In an exemplary embodiment, evaluating the one or more writing samples is performed by AI Teaching module 142, as described above, which provides the educational level of user 118 based on the results of the evaluation of the one or more writing samples. In an exemplary embodiment, user 118 is notified of one or more of their educational level, and/or an educational entry point. For example, user 118 is notified of their education entry point, “You'll Start with Sentence Structure”, as illustrated in FIG. 2D.

At step 306, one or more learning module(s) is provided to user 118 based on their educational level. The one or more learning module(s) is provided adaptively based on the educational level of user 118, such that the higher the educational level of the user the more difficult the one or more learning module(s) provided to user 118. In embodiments, the one or more learning module(s) includes, but is not limited to, one of four levels: sentence structure, simple paragraphs, extended paragraphs, or five paragraph essays, as illustrated in FIG. 2E-G. In an exemplary embodiment, the one or more learning module(s) is provided by Instructional Teaching module 140, as described above.

At step 308, user 118 provides one or more responses to the one or more learning module(s) provided by Instructional Teaching module 140. The one or more responses are evaluated by one or more AI or machine learning models/algorithms. In embodiments, the one or more AI or machine learning models/algorithms provide at least one score, and/or at least one feedback to user 118 based on the one or more responses. In an exemplary embodiment, the one or more AI or machine learning models/algorithms is AI teaching module 142 which is configured to score the user 118 and provide feedback to the user. For example, the AI teaching module 142 can provide, as the at least one score, a grade or progress level. The AI teaching module 142 can provide feedback based on the work submitted by the user 118. For example, if a writing sample of the user 118 includes a spelling error or grammatical error, the AI teaching module 142 can explain the error and provide feedback to correct the error. In another example, if a writing sample is technically correct, the AI teaching module 142 can provide feedback to improve the sentence and improve the score.

At step 310, one or more of the score, the user feedback, and/or at least one additional learning module(s) are output to user 118. In embodiments, the score is in a range from 1-10, wherein 1 represents the lowest score and 10 represents the highest score, and can be provided as a numerical indicator, and/or as a number of graphical icons, such as a number of stars. In embodiments, the user feedback includes textual and/or graphical feedback based on the results of AI analysis provided in step 308. In an exemplary embodiment, FIG. 2H-I illustrate feedback output in accordance with step 310. In embodiments, the at least one additional learning module(s) are provided as described with respect to step 306. For example, in response to evaluation of the one or more responses in step 308, and the score derived therefrom, the at least one additional learning module(s) is provided. In embodiments, the one or more additional learning module(s) is provided adaptively, as described in step 306, based on the score, such that as a user's 118 score is continuously evaluated and user's 118 learning journey evolves thereby. For example, as user 118 is provide the one or more learning modules they are continuously scored, which provides the basis for selection of a next learning module. Advantageously, method 300 utilizes artificial intelligence to both place user 118 in a specific writing level, thereby providing tailored instruction based on the user's capabilities, and score/provide feedback on their writing as they progress.

As used in the description herein and throughout the claims that follow, “a”, “an”, and “the” include plural references unless the context clearly dictates otherwise. Also, as used in the description herein and throughout the claims that follow, the meaning of “in” includes “in” and “on” unless the context clearly dictates otherwise. While the above is a complete description of specific examples of the disclosure, additional examples are also possible. Thus, the above description should not be taken as limiting the scope of the disclosure which is defined by the appended claims along with their full scope of equivalents.

The foregoing disclosure encompasses multiple distinct examples with independent utility. While these examples have been disclosed in a particular form, the specific examples disclosed and illustrated above are not to be considered in a limiting sense as numerous variations are possible. The subject matter disclosed herein includes novel and non-obvious combinations and sub-combinations of the various elements, features, functions and/or properties disclosed above both explicitly and inherently. Where the disclosure or subsequently filed claims recite “a” element, “a first” element, or any such equivalent term, the disclosure or claims is to be understood to incorporate one or more such elements, neither requiring nor excluding two or more of such elements. As used herein regarding a list, “and” forms a group inclusive of all the listed elements. For example, an example described as including A, B, C, and D is an example that includes A, includes B, includes C, and also includes D. As used herein regarding a list, “or” forms a list of elements, any of which may be included. For example, an example described as including A, B, C, or D is an example that includes any of the elements A, B, C, and D. Unless otherwise stated, an example including a list of alternatively-inclusive elements does not preclude other examples that include various combinations of some or all of the alternatively-inclusive elements. An example described using a list of alternatively-inclusive elements includes at least one element of the listed elements. However, an example described using a list of alternatively-inclusive elements does not preclude another example that includes all of the listed elements. And, an example described using a list of alternatively-inclusive elements does not preclude another example that includes a combination of some of the listed elements. As used herein regarding a list, “and/or” forms a list of elements inclusive alone or in any combination. For example, an example described as including A, B, C, and/or D is an example that may include: A alone; A and B; A, B and C; A, B, C, and D; and so forth. The bounds of an “and/or” list are defined by the complete set of combinations and permutations for the list.

It should be understood, of course, that the foregoing relates to exemplary embodiments of the disclosure and that modifications can be made without departing from the spirit and scope of the disclosure as set forth in the following claims.

What is claimed is:

1. A computer implemented method for adaptive tutoring, comprising:
receiving, at a processor, one or more writing samples from a user;
evaluating, using one or more Artificial Intelligence models, the one or more writing samples to determine an educational level of the user;
providing, by the processor, one or more learning modules to the user, wherein the one or more learning modules are provided adaptively based on the educational level of the user;
receiving, at the processor, one or more responses from the user to the one or more learning modules;
evaluating, using the one or more Artificial Intelligence models, to determine one or more of: a score, or at least one user feedback;
outputting, by the processor, at least one of: the score, the at least one user feedback, or at least one additional learning module.

2. The computer implemented method of claim 1, wherein the one or more writing samples are receiving in response to at least one baseline writing sample.

3. The computer implemented method of claim 1, wherein the at least one additional learning module is output adaptively based on the score.

4. A system for adaptive tutoring comprising:
At least one processor, and at least one memory storing instructions that, when executed, cause the processor to perform a method, the method comprising:
receiving, at the at least one processor, one or more writing samples from a user;
evaluating, using one or more Artificial Intelligence modules, the one or more writing samples to determine an educational level of the user;
providing, by the at least one processor, one or more learning modules to the user, wherein the one or more learning modules are provided adaptively based on the educational level of the user;
receiving, at the at least one processor, one or more responses from the user to the one or more learning modules;
evaluating, using the one or more Artificial Intelligence modules, to determine one or more of: a score, or at least one user feedback;
outputting, by the at least one processor, at least one of: the score, the at least one user feedback, or at least one additional learning module.

5. The system of claim 4, wherein the one or more writing samples are receiving in response to at least one baseline writing sample.

6. The system of claim 4, wherein the at least one additional learning module is output adaptively based on the score.

7. A system for interactive artificial intelligence-enhanced writing tutoring, comprising:
a processing device operative to execute an instructional application stored in a memory, the instructional application including an AI teaching module configured to:
receive a baseline writing sample from a user via a user interface;
evaluate the baseline writing sample to determine a writing proficiency level of the user;
generate and output a plurality of tailored learning modules based on the determined writing proficiency level;
receive responses from the user to the tailored learning modules;
evaluate the user responses to generate a performance score and user feedback; and
update a user writing portfolio based on the evaluated responses;
a communications interface operatively coupled to the processing device and configured to transmit and receive data with a remote educator dashboard;
an output interface operatively coupled to the processing device and configured to display at least one of the performance score, the user feedback, or additional learning modules adaptively provided based on the evaluated responses; and
an educator dashboard configured to present user performance metrics, the educator dashboard being remotely accessible via the communications interface.

8. The system of claim 7, wherein the AI teaching module comprises: one or more machine learning algorithms trained to evaluate grammatical correctness, writing style, and content organization of the baseline writing sample and the user responses.

9. The system of claim 7, wherein the plurality of tailored learning modules comprise: at least one of a sentence structure module, a simple paragraph module, an extended paragraph module, or a five paragraph essay module.

10. The system of claim 7, wherein the educator dashboard is configured to display historical performance metrics, including: performance score trends over a plurality of tutoring sessions.
